(19) United States
(12) Patent Application Publication
(10) Pub. No.: US 2025/0286153 A1
(43) Pub. Date: Sep. 11, 2025

(54) BATTERY PACK LEAKAGE INSPECTION SYSTEM AND APPARATUS THEREFOR

(71) Applicant: HYUNDAI MOBIS CO., LTD., Seoul (KR)

(72) Inventors: Seong Jin KIM, Yongin-si (KR); Jong Ha KIM, Yongin-si (KR); Shin Young KANG, Yongin-si (KR); Yoo Hwan HWANG, Yongin-si (KR); Myung Jae SHIN, Yongin-si (KR); Sae Yong JEON, Yongin-si (KR); Chan Hoe HEO, Yongin-si (KR); Jae In KIM, Yongin-si (KR); Chung Sik JEONG, Yongin-si (KR); Wang Ju KIM, Yongin-si (KR)

(73) Assignee: HYUNDAI MOBIS CO., LTD., Seoul (KR)

(21) Appl. No.: 18/930,411

(22) Filed: Oct. 29, 2024

(30) Foreign Application Priority Data
Mar. 5, 2024 (KR) 10-2024-0031496

(51) Int. Cl. H01M 10/42; G01M 3/00

(52) U.S. Cl. CPC H01M 10/4228; G01M 3/00; H01M 10/4285

(57) ABSTRACT

A battery pack leakage inspection system and an apparatus therefor are provided. The system includes: a base frame including a support on which a battery pack is placed; a first mask installed on the base frame to mask a coolant channel nipple of the battery pack; a second mask installed on the base frame separately from the first mask to mask a pressure regulator of the battery pack; and a third mask installed on the base frame separately from the second mask to mask a high voltage plug and an integrated charging control unit (ICCU) plug of the battery pack.

### CROSS-REFERENCE TO RELATED APPLICATION(S)

The present application claims priority to and the benefit under 35 USC § 119 Korean Patent Application No. 10-2024-0031496, filed on Mar. 5, 2024, in the Korean Intellectual Property Office, the entire disclosure of which is hereby incorporated by reference in its entirety for all purposes.

### BACKGROUND

### 1. Field

The disclosure relates to a battery pack leakage inspection system and a battery pack leakage inspection apparatus.

### 2. Description of the Related Art

Battery packs used in electric vehicles and the like have a structure in which a plurality of battery cells are stacked and then electrically connected. The battery pack is a key component in the electric vehicle or the like, and thus required to be sealed to maintain airtightness for electrical stability and safety while being electrically connected to the outside.

In general, the battery pack is required to pass two leakage inspections for a coolant channel and a pack interior channel, and needs masking for a coolant channel nipple, a pressure regulator, etc. to undergo the two leakage inspections.

However, the coolant channel nipple and the pressure regulator are different in position according to vehicle models, and thus addition of a new vehicle model causes a problem of increasing investment costs due to the installation of a dedicated masking jig. As the number of vehicle models increases due to the recent rising demand for electric vehicles, the shapes of battery pack products are diversifying. Accordingly, there is a trend toward a common use of an automated system for various vehicles in an assembly process.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

An aspect of the disclosure is to provide a battery pack leakage inspection system that is developed for battery packs corresponding to various vehicle models, thereby reducing investment costs due to construction of common use facilities for various vehicle models and addition of new vehicle models.

Technical problems of the disclosure are not limited to the forementioned problems, and other unmentioned problems can be clearly understood from the following description by those skilled in the art.

In a general aspect of the disclosure, a battery pack leakage inspection system includes: a base frame including a support on which a battery pack is placed; a first mask installed on the base frame and configured to mask a coolant channel nipple of the battery pack; a second mask installed on the base frame separately from the first mask and configured to mask a pressure regulator of the battery pack; and a third mask installed on the base frame separately from the second mask and configured to mask a high voltage plug and an integrated charging control unit (ICCU) plug of the battery pack.

The first mask may include a first module and a second module, each of which is provided with a first masking jig connected to the coolant channel nipple, wherein the first module and the second module may respectively include multi-axis servo actuators configured to be driven individually to adjust a distance and an angle based on a position of the coolant channel nipple.

Each of the first module and the second module may include: a first base plate connected to a support plate and configured to move up and down along a Z-axis; a first operation plate connected to the first base plate and configured to move forward and backward along a Y-axis; a second operation plate connected to the first operation plate and configured to move forward and backward along an X-axis; and a jig plate connected to the second operation plate and configured to be rotatable around the Z-axis, the jig plate mounted with the first masking jig.

The battery pack leakage inspection system may further include: a unit plate connected to the base frame and configured to move forward and backward along the Y-axis, to which the support plate is secured, wherein the first module and the second module may be supported on the unit plate and configured to move as a single body.

The second mask may include a rotation module including a second masking jig connected to the pressure regulator of the battery pack, and a support module to which the rotation module is rotatably connected, wherein the rotation module may include at least one pair of rotation modules operating individually corresponding to the position of the pressure regulator and configured to be adjusted in position and angle.

The support module may include: a first body secured to a first support frame and configured to move forward and backward along the X-axis on the base frame, and provided with a ring gear; and a second body secured to a lower end of the first body and provided with a ring rail on a bottom surface thereof, wherein the rotation module may include: a prop connected to the ring rail; a first bracket disposed on the prop; a roller pinion rotatably connected to the first bracket and engaging with the ring gear; and a second bracket configured to move along the prop and mounted with the second masking jig.

The prop may include a structure configured to extend radially from a center of the ring gear, and rotate along the ring rail around the center of the ring gear.

The second masking jig may be mounted on the second bracket and configured to move up and down on the second bracket.

The third mask may include: a second support frame configured to move forward and backward along an X-axis on the base frame; a second base plate connected to the second support frame and configured to move up and down along a Z-axis; and a jig frame connected to the second base plate and configured to move forward and backward along a Y-axis, the jig frame mounted with a third masking jig to be connected to the high voltage plug and the ICCU plug.

The third masking jig may be mounted on the jig frame and configured to move forward and backward on the jig frame.

In another general aspect of the disclosure, a battery pack leakage inspection apparatus includes: a base frame including a support on which a battery pack is placed; a first mask installed on the base frame and configured to mask a coolant channel nipple of the battery pack, the first mask including: a first module including a first multi-axis servo actuator provided with a first masking jig connected to the coolant channel nipple; and a second module including a second multi-axis servo actuator provided with a second masking jig connected to the coolant channel nipple; a controller configured to control driving the first multi-axis servo actuator and the second multi-axis servo actuator to adjust distances and angles based on a position of the coolant channel nipple; a second mask installed on the base frame separately from the first mask and configured to mask a pressure regulator of the battery pack; and a third mask installed on the base frame separately from the second mask and configured to mask a high voltage plug and an integrated charging control unit (ICCU) plug of the battery pack.

Each of the first module and the second module may include: a first base plate connected to a support plate; a first operation plate connected to the first base plate; a second operation plate connected to the first operation plate; and a jig plate connected to the second operation plate, the jig plate mounted with the first masking jig, wherein the controller may be further configured to: control movement of the first base plate to move up and down along a Z-axis; control movement of the first operation plate to move forward and backward along a Y-axis; control movement of the second operation plate to move forward and backward along an X-axis; and control rotation of the jig plate around the Z-axis.

The battery pack leakage inspection apparatus may further include: a unit plate connected to the base frame, wherein the controller may be further configured to control movement of the unit plate to move forward and backward along the Y-axis, to which the support plate is secured, wherein the first module and the second module may be supported on the unit plate and configured to move as a single body.

The second mask may include a rotation module including a second masking jig connected to the pressure regulator of the battery pack, and a support module to which the rotation module is rotatably connected, wherein the rotation module may include at least one pair of rotation modules operating individually corresponding to the position of the pressure regulator and configured to be adjusted in position and angle.

The support module may include: a first body secured to a first support frame and provided with a ring gear; and a second body secured to a lower end of the first body and provided with a ring rail on a bottom surface thereof, wherein the controller may be further configured to control movement of the first body to move forward and backward along the X-axis on the base frame, and wherein the rotation module may include: a prop connected to the ring rail; a first bracket disposed on the prop; a roller pinion rotatably connected to the first bracket and configured to engage with the ring gear; and a second bracket configured to move along the prop and mounted with the second masking jig.

The prop may include a structure configured to extend radially from a center of the ring gear, and rotate along the ring rail around the center of the ring gear.

The second masking jig may be mounted on the second bracket, wherein the controller may be further configured to control movement of the second masking jig to move up and down on the second bracket.

The third mask may include: a second support frame; a second base plate connected to the second support frame; a jig frame connected to the second base plate and mounted with a third masking jig for connection to the high voltage plug and the ICCU plug, wherein the controller may be further configured to: control movement of the second support frame to move forward and backward along an X-axis on the base frame; control movement of the second plate to move up and down along a Z-axis; and control movement of the jig frame to move forward and backward along a Y-axis.

The third masking jig may be mounted on the jig frame, wherein the controller may be further configured to control movement of the third masking jig to move forward and backward on the jig frame.

### BRIEF DESCRIPTION OF THE DRAWINGS

FIG. 1 is a view schematically illustrating a battery pack leakage inspection system according to an embodiment of the disclosure.

FIG. 2 is a view schematically illustrating a battery pack to be subjected to a leakage inspection.

FIGS. 3 to 5 are plan, front and lateral views, respectively, illustrating a first masking unit in a battery pack leakage inspection system, respectively.

FIG. 6 is a view illustrating a first masking jig of a first masking unit.

FIGS. 7 and 8 are plant and lateral views, respectively, illustrating a second masking unit in a battery pack leakage inspection system.

FIG. 9 is a plan view illustrating a coupling structure between a rotation module and a support module in a second masking unit.

FIG. 10 is a view illustrating a second masking jig of a second masking unit.

FIGS. 11 to 13 are plan, front and lateral views, respectively, illustrating a third masking unit in a battery pack leakage inspection system.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, embodiments of the present invention will be described in detail with reference to the accompanying drawings, and components which are the same or correspond to each other will be denoted by the same or corresponding reference numerals in all drawings, and redundant descriptions will be omitted.

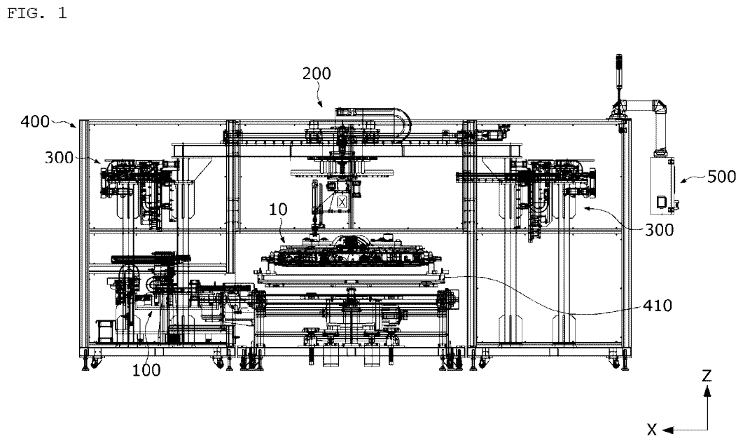

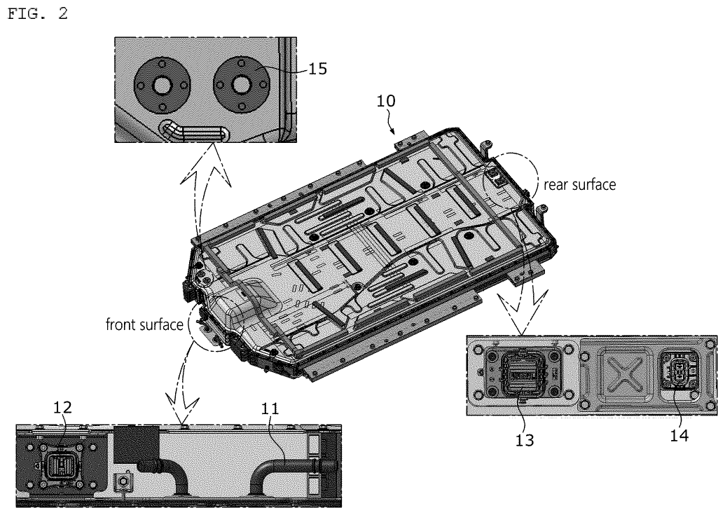

FIG. 1 is a view schematically illustrating a battery pack leakage inspection system according to an embodiment of the disclosure, and FIG. 2 is a view schematically illustrating a battery pack to be subjected to a leakage inspection.

Referring to FIGS. 1 and 2, the battery pack leakage inspection system according to an embodiment of the disclosure may include a first masking unit 100, a second masking unit 200, a third masking unit 300, and a base frame 400. The masking units may be referred to as masks, e.g., a first mask, a second mask, and a third mask. The battery pack leakage inspection system may include one or more controllers (e.g., processors) configured to control movement of various components described below.

The base frame 400 may form a frame structure for installing the first masking unit 100, the second masking unit 200, and the third masking unit 300. The first masking unit 100, the second masking unit 200, and the third masking unit 300 may be installed separately from each other.

The base frame 400 may be provided with a support 410 on which a battery pack 10 is placed. According to an embodiment, the battery pack 10 may be transferred by a conveyor and seated on the support 410.

As shown in FIG. 2, the battery pack 10 includes a coolant channel nipple 11 and a high voltage plug 12 on the front surface thereof, a high voltage plug 13 and an integrated charging control unit (ICCU) plug 14 on the rear surface thereof, and a pressure regulator 15 on the top surface thereof.

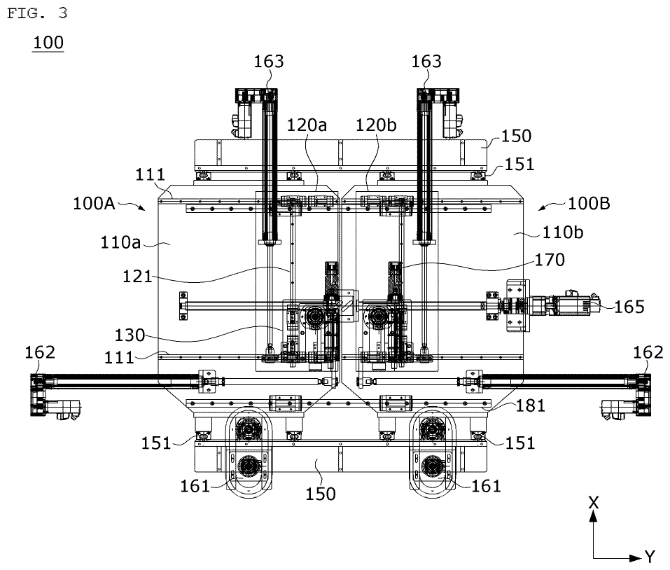

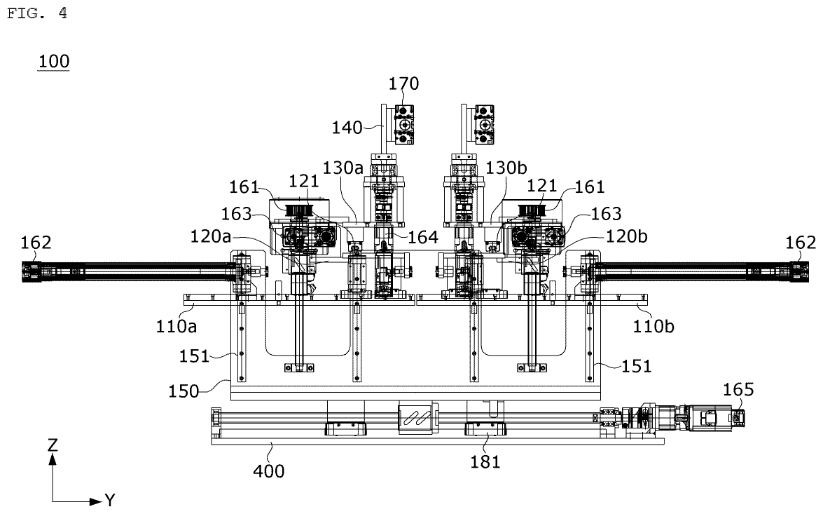

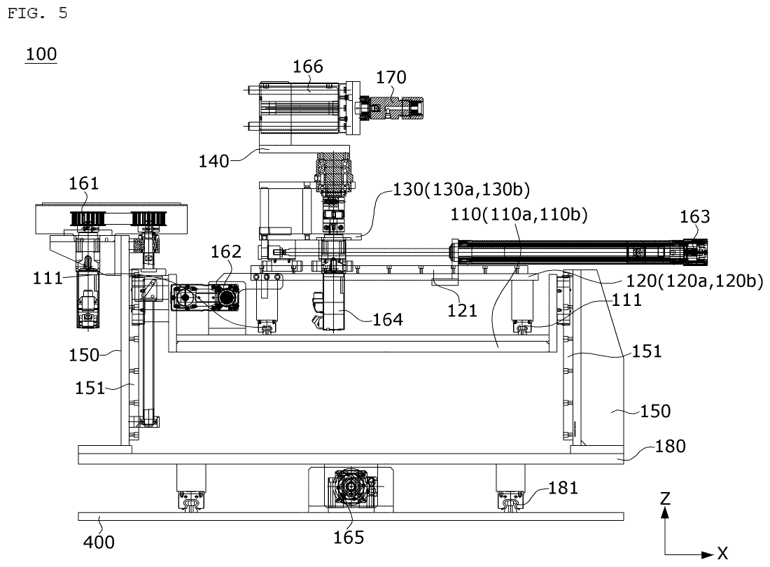

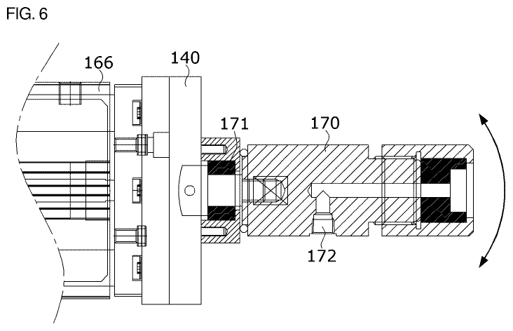

The first masking unit will be described with reference to FIGS. 3 to 6. FIGS. 3 to 5 show the first masking unit in the battery pack leakage inspection system, and FIG. 6 shows a first masking jig of the first masking unit.

The first masking unit 100 is installed on the base frame 400 and may be configured to mask the coolant channel nipple 11 of the battery pack 10. According to an embodiment, the first masking unit 100 may be placed on the front surface of the battery pack 10.

The first masking unit 100 may include a first module 100A and the second module 100B, each of which is provided with a first masking jig 170 connected to the coolant channel nipple 11.

According to an embodiment, the first module 100A and the second module 100B are respectively configured as multi-axis servo actuators and driven individually to adjust distances and angles based on the positions of the coolant channel nipples 11. In other words, the first module 100A and the second module 100B are symmetrically arranged left and right corresponding to two coolant channel nipples 11, and driven each individually to adjust the distances and angles corresponding to the positions of the coolant channel nipple 11.

Each of the first module 100A and the second module 100B may include a first base plate 110, a first operation plate 120, a second operation plate 130, and a jig plate 140.

The first base plate 110, the first operation plate 120, the second operation plate 130, and the jig plate 140 may be configured to move along different axes.

The first base plate 110 may be connected to a support plate 150 so as to move up and down along the Z-axis. Here, the Z-axis may refer to a direction corresponding to up and down movement from above the top surface of the battery pack 10.

The first base plate 110 may be connected to a first linear motion (LM) guide 151 extending up and down along the surface of the vertically standing support plate 150. Further, the first base plate 110 is connected to a first actuator 161 and moves up and down toward the top surface of the battery pack 10 along the first LM guide 151 through the operation of the first actuator 161. According to an embodiment, the first actuator 161 may be based on a belt-pulley system including by a belt and a pulley.

The first base plate 110a of the first module 100A and the first base plate 110b of the second module 100B may be separated from each other and moved up and down individually. Therefore, the first base plate 110a of the first module 100A and the first base plate 110b of the second module 100B may be adjusted to be at different positions or at the same position along the Z-axis.

The first operation plate 120 may be connected to the first base plate 110 so as to move forward and backward along the Y-axis. Here, the Y-axis may refer to a direction corresponding to forward and backward movement toward the lateral surface of the battery pack 10.

The first operation plate 120 may be connected to a second LM guide 111 extending from the surface of the first base plate 110 in a Y-axis direction. Further, the first operation plate 120 may be connected to a second actuator 162 and reciprocate forward and backward toward the lateral surface of the battery pack 10 along the second LM guide 111 through the operation of the second actuator 162. According to an embodiment, the second actuator 162 may include an electric cylinder.

A first operation plate 120a on the first base plate 110a of the first module 100A and a first operation plate 120b on the first base plate 110b of the second module 100B may move each individually in the Y-axis direction.

The second operation plate 130 may be connected to the first operation plate 120 so as to move forward and backward along an X-axis. Here, the X-axis may refer to a direction corresponding to forward and backward movement toward the front surface of the battery pack 10.

The second operation plate 130 may be connected to a third LM guide 121 extending from the surface of the first operation plate 120 in an X-axis direction. Further, the second operation plate 130 may be connected to a third actuator 163 and reciprocate forward and backward toward the front surface of the battery pack 10 along the third LM guide 121 through the operation of the third actuator 163. According to an embodiment, the third actuator 163 may include an electric cylinder.

The second operation plate 130a on the first operation plate 120a of the first module 100A and the second operation plate 130b on the first operation plate 120b of the second module 100B may move each individually in the X-axis direction.

The jig plate 140 may be connected to the second operation plate 130 so as to rotate around the Z-axis. The jig plate 140 may be connected to a fourth actuator 164 on the second operation plate 130 and rotate through the operation of the fourth actuator 164. According to an embodiment, the fourth actuator 164 may include a servo motor.

The first masking jig 170 may be mounted to the jig plate 140. The first masking jig 170 may be selectively connected to the coolant channel nipple 11 while moving forward and backward through a forward-and-backward motion cylinder 166.

The first masking jig 170 may be connected to the coolant channel nipple as moved forward, thereby masking the coolant channel nipple.

The first masking jig 170 may be provided with a urethane pad 171 inside a rear end thereof to be fastened to the jig plate 140, so that the first masking jig 170 can tilt at a predetermined angle to the jig plate 140. For example, the first masking jig 170 may use the elasticity of the urethane pad 171 to tilt at an angle of 4 to 5 degrees to the jig plate 140 so as to be easily coupled to the coolant channel nipple 11.

The first masking jig 170 may be provided with an air hole 172. The air hole 172 may be connected to an air injection pipe (not shown) and used to inspect the leakage of the coolant channel. While the coolant channel nipple 11 is masked with the end of the first masking jig 170, air may be injected into a coolant channel through the air hole 172.

Each support plate 150 of the first module 100A and the second module 100B may be integrally secured to a unit plate 180. The unit plate 180 may be connected to the base frame 400 so as to move forward and backward along the Y-axis.

The unit plate 180 may be connected to a fourth LM guide 181 extending to the base frame 400 in the Y-axis direction. Further, the unit plate 180 may be connected to a fifth actuator 165 and reciprocate forward and backward along the fourth LM guide 181 through the operation of the fifth actuator 165. According to an embodiment, the fifth actuator 165 may include an electric cylinder.

Accordingly, the first module 100A and the second module 100B may be supported on the unit plate 180 and configured to move as a single unit.

When the battery pack 10 is transferred, the unit plate 180 moves to position the first module 100A and the second module 100B to face toward the coolant channel nipple 11 provided in front of the battery pack 10. In addition, the first module 100A and the second module 100B may be driven individually to adjust the distance and angle corresponding to the position of the coolant channel nipple 11. In other words, each first masking jig 170 moves along the Z-axis, the Y-axis, and the X-axis to face the coolant channel nipple 11, and rotates. Then, the first masking jig 170 moves forward to mask the coolant channel nipple 11.

With this method, the first masking jig 170 may be adjusted to be positioned and directed corresponding to the position and direction of the coolant channel nipple 11 of the battery pack 10 even though the coolant channel nipples 11 of the battery packs 10 are different in position and direction according to the vehicle models.

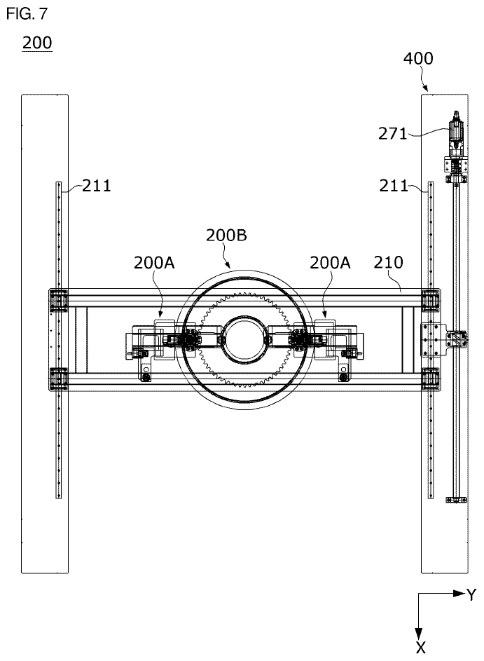

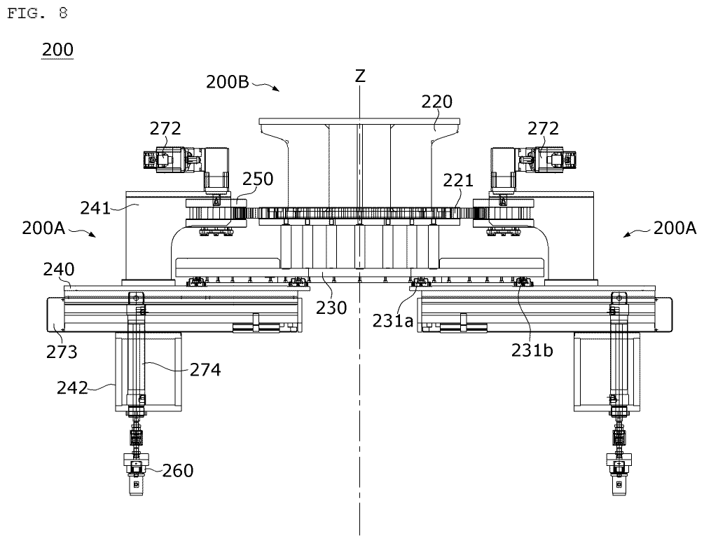

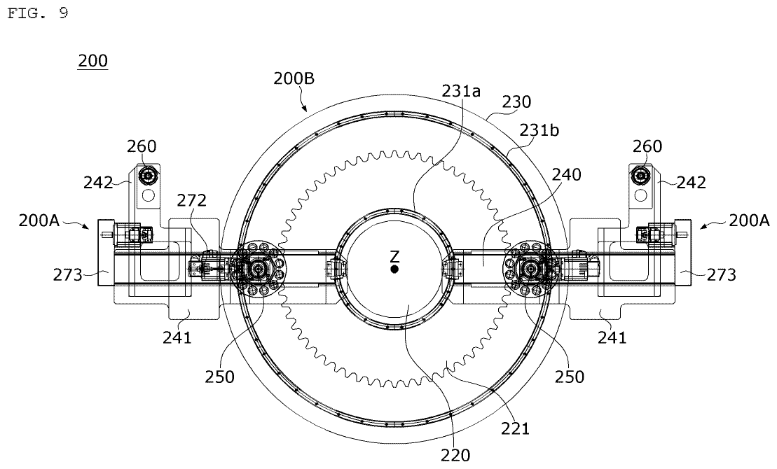

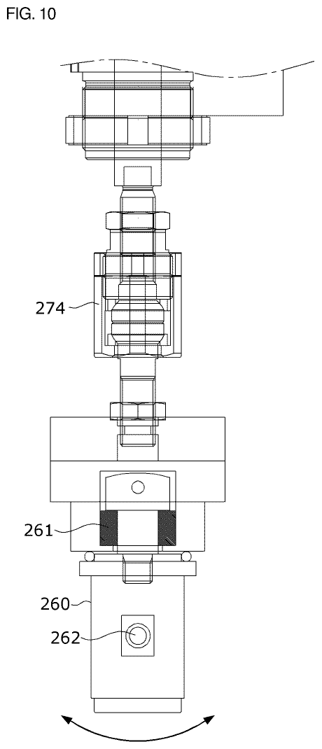

The second masking unit will be described with reference to FIGS. 7 to 10. FIGS. 7 and 8 show the second masking unit in a battery pack leakage inspection system, FIG. 9 shows a coupling structure between a rotation module and a support module in the second masking unit, and FIG. 10 shows a second masking jig of the second masking unit.

The second masking unit 200 may be installed on the base frame 400 separately from the first masking unit 100, and configured to mask the pressure regulator 15 provided on the top surface of the battery pack 10. The second masking unit 200 may be installed on the base frame 400 so as to be placed above the top surface of the battery pack 10.

The second masking unit 200 may include a rotation module 200A including a second masking jig 260 connected to the pressure regulator 15, and a support module 200B supporting the rotation module 200A.

The support module 200B may include a first body 220 secured to a first support frame 210 moving forward and backward on the base frame 400 along the X-axis on the base frame 400, and a second body 230 secured to a lower end of the first body 220.

The first support frame 210 may be connected to a fifth LM guide 211 extending on the base frame 400 along the X-axis. The first support frame 210 may be connected to a sixth actuator 271 and reciprocate forward and backward along the fifth LM guide 211 through the operation of the sixth actuator 271. According to an embodiment, the sixth actuator 271 may include an electric cylinder.

The first body 220 may be mounted and secured to the bottom surface of the first support frame 210. The first body 220 may be provided with a ring gear 221 on the circumference thereof. The ring gear 221 may have a structure that gear teeth protrude radially from the center of the first body 220.

The second body 230 may be shaped like a disk having a diameter approximately larger than the diameter of the ring gear 221.

The second body 230 may be provided with a ring rail 231 concentric with the ring gear 221 on the bottom surface thereof facing the battery pack 10. There may be provided a single rail 231 or a plurality of ring rails 231. In this embodiment, there are provided two ring rails 231, i.e., a first ring rail 231a and a second ring rail 231b different in diameter from each other, but the disclosure is not limited to this embodiment.

The rotation module 200A may be rotatably connected to the support module 200B. The rotation module 200A may be provided as a pair corresponding to the pressure regulators 15. In this embodiment, there is provided one pair of rotation modules 200A, but the disclosure is not limited to this embodiment.

One pair of rotation modules 200A may be configured to operate individually and be adjusted in position and angle corresponding to the positions of the pressure regulators 15.

Referring to FIGS. 7 to 10, the rotation module 200A may include a prop 240 connected to the ring rail 231 on the bottom surface of the second body 230, a first bracket 241 disposed on the prop 240, a roller pinion 250 rotatably connected to the first bracket 241, a second bracket 242 configured to move along the prop 240, and the second masking jig 260 mounted to the second bracket 242.

The prop 240 may be roughly shaped like a long beam, and disposed to have a structure of extending radially from the center of the ring gear 221. Further, the prop 240 may rotate along the ring rail 231 around the center of the ring gear 221.

The first bracket 241 may be provided on the prop 240, and the roller pinion 250 may be rotatably connected to the first bracket 241 and engage with the ring gear 221. According to an embodiment, the roller pinion 250 may be connected to a servo motor 272 and driven to rotate. As the roller pinion 250 rotates in the state that the roller pinion 250 engages with the ring gear 221, the prop 240 rotates along the ring rail 231.

The second bracket 242 is provided below the prop 240, and the second bracket 242 may move along the prop 240. The second bracket 242 may be connected to a seventh actuator 273 and reciprocate forward and backward along the prop 240 through the operation of the seventh actuator 273. According to an embodiment, the seventh actuator 273 may include an electric cylinder.

The second masking jig 260 may be mounted to move up and down on the second bracket 242. According to an embodiment, the second masking jig 260 may be selectively connected to the pressure regulator while moving up and down through an up-and-down motion cylinder 274. The second masking jig 260 is connected to the pressure regulator 15 as moved down, thereby masking the pressure regulator 15.

The second masking jig 260 may be provided with a urethane pad 261 inside a rear end thereof to be fastened to the up-and-down motion cylinder 274, so that the second masking jig 260 can tilt at a predetermined angle. For example, the second masking jig 260 may use the elasticity of the urethane pad 261 to tilt at an angle of 4 to 5 degrees so as to be easily coupled to the pressure regulator 15.

The second masking jig 260 may be provided with an air hole 262. The air hole 262 may be connected to the air injection pipe and used to inspect the leakage inside the battery pack 10. While the pressure regulator 15 is masked with the end of the second masking jig 260, air may be injected into the battery pack 10 through the air hole 262.

When the battery pack 10 is transferred, the first support frame 210 moves to position the support module 200B and the rotation module 200A above the pressure regulators 15 provided on the top surface of the battery pack 10. In addition, one pair of rotation modules 200A may be driven individually to adjust the position and angle corresponding to the position of the pressure regulators 15. In other words, each second masking jig 260 rotates along the ring rail 231 to face the pressure regulator 15, and moves forward and backward along the prop 240. Then, the second masking jig 260 moves down to mask the pressure regulator 15.

With this method, the second masking jig 260 may be adjusted to be positioned corresponding to the position of the pressure regulator 15 of the battery pack 10 even though the pressure regulators 15 of the battery packs 10 are different in position according to the vehicle models.

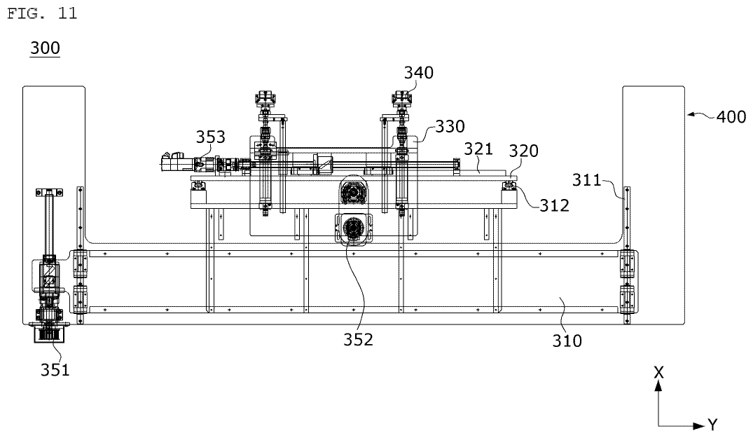

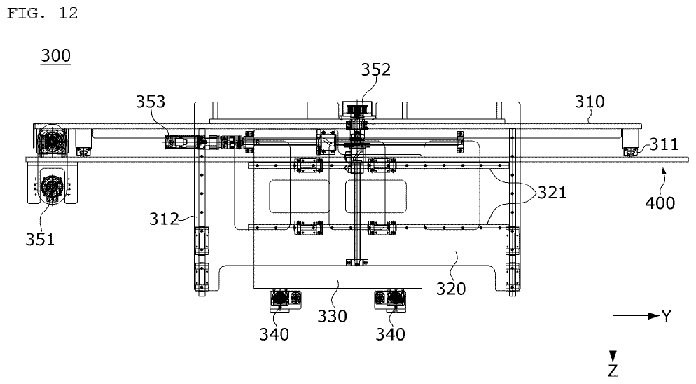

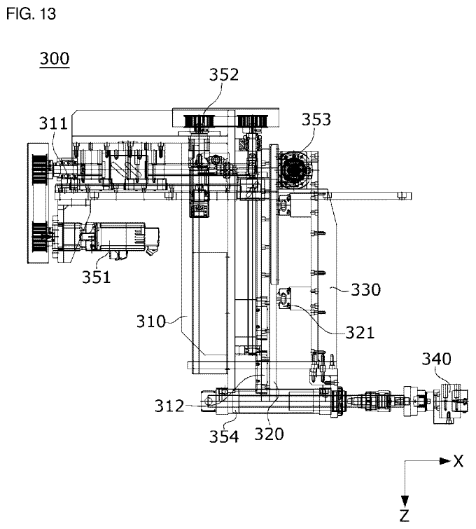

The third masking unit will be described with reference to FIGS. 11 to 13. FIGS. 11 to 13 show the third masking unit in the battery pack leakage inspection system.

The third masking unit 300 may be installed on the base frame 400 separately from the second masking unit 200, and configured to mask the high voltage plugs 12 and 13 provided on the front and rear surfaces of the battery pack 10 and the ICCU plug 14 provided on the rear surface of the battery pack 10. According to an embodiment, the third masking unit 300 may be provided as a pair and placed on the front and rear surfaces of the battery pack 10, respectively.

The third masking unit 300 may include a second support frame 310 moving forward and backward on the base frame 400 along the X-axis, a second base plate 320 connected to the second support frame 310, and a jig frame 330 connected to the second base plate 320.

The second support frame 310 may be connected to a sixth LM guide 311 extending on the base frame 400 along the X-axis. The second support frame 310 may be connected to an eighth actuator 351 and reciprocate forward and backward along the sixth LM guide 311 through the operation of the eighth actuator 351. According to an embodiment, the eighth actuator 351 may be based on a belt-pulley system including by a belt and a pulley.

The second base plate 320 may be connected to the second support frame 310 so as to move up and down along the Z-axis.

The second base plate 320 may be connected to a seventh LM guide 312 extending from the second support frame 310 in the Z-axis direction. Further, the second base plate 320 may be connected to a ninth actuator 352 and reciprocate up and down along the seventh LM guide 312 through the operation of the ninth actuator 352. According to an embodiment, the ninth actuator 352 may be based on a belt-pulley system including by a belt and a pulley.

The jig frame 330 may be connected to the second base plate 320 so as to move forward and backward along the Y-axis.

The jig frame 330 may be connected to an eighth LM guide 321 extending from the second base plate 320 in the Y-axis direction. Further, the jig frame 330 may be connected to a tenth actuator 353 and reciprocate forward and backward along the eighth LM guide 321 through the operation of the tenth actuator 353. According to an embodiment, the tenth actuator 353 may include an electric cylinder.

A third masking jig 340 may be mounted to the jig frame 330. The third masking jig 340 may be selectively connected to the high voltage plugs 12 and 13 and the ICCU plug 14 as mounted to move forward and backward through a forward-and-backward motion cylinder 354.

The third masking jig 340 may be connected to the high voltage plugs 12 and 13 and the ICCU plug 14 as moved forward, thereby masking the high voltage plugs 12 and 13 and the ICCU plug 14.

The third masking jig 340 may be provided with a urethane pad 341 inside a rear end thereof to be fastened to the forward-and-backward motion cylinder 354, so that the third masking jig 340 can tilt at a predetermined angle. For example, the third masking jig 340 may use the elasticity of the urethane pad 341 to tilt at an angle of about 4 to 5 degrees so as to be easily coupled to the high voltage plugs 12 and 13 and the ICCU plug 14.

Meanwhile, the leakage inspection for the battery pack 10 may be performed through the first masking unit 100 and the second masking unit 200.

In the state that the first masking unit 100 is driven to mask the coolant channel nipple 11 with the first masking jig 170, air is injected into the coolant channel through the air hole 172 provided in the first masking jig 170. The amount of air to be injected and an injection time may be controlled and checked through a control device 500.

When the injection of air is completed, it is checked whether there is a change in the amount of injected air. When the change in the amount of injected air satisfies an airtightness condition, it is identified that there is no problem with the coolant channel.

In the state that the second masking unit 200 is driven to mask the pressure regulator 15 with the second masking jig 260, air is injected into the battery pack 10 through the air hole 262 provided in the second masking jig 260. The amount of air to be injected and an injection time may be controlled and checked through a control device 500.

When the injection of air is completed, it is checked whether there is a change in the amount of injected air. When the change in the amount of injected air satisfies an airtightness condition, it is identified that there is no problem with a packaging state of the battery pack 10. In other words, the airtightness in the battery pack 10 is guaranteed.

In this way, according to an embodiment of the disclosure, the masking jigs 170, 260, and 340 are automatically adjustable in position, angle and direction and thus used in common regardless of vehicle models even though the battery packs are different in shape according to the vehicle models. Accordingly, common use facilities for various vehicle models are constructed, thereby reducing investment costs due to addition of new vehicle models.

According to an embodiment of the disclosure, there is provided a battery pack leakage inspection system to reduce investment costs due to construction of common use facilities for various vehicle models and addition of new vehicle models.

The effects of the disclosure are not limited to the foregoing effects, and other unmentioned effects can be clearly understood from the appended claims by those skilled in the art.

Although a few embodiments of the disclosure have been described, it will be understood by a person having ordinary knowledge in the art that various modifications and changes can be made without departing from the spirit and scope of the disclosure set forth in the appended claims. In addition, differences related to these modifications and changes should be construed as falling within the scope of the disclosure defined in the appended claims.

What is claimed is:

1. A battery pack leakage inspection system comprising:
a base frame comprising a support on which a battery pack is placed;
a first mask installed on the base frame and configured to mask a coolant channel nipple of the battery pack;
a second mask installed on the base frame separately from the first mask and configured to mask a pressure regulator of the battery pack; and
a third mask installed on the base frame separately from the second mask and configured to mask a high voltage plug and an integrated charging control unit (ICCU) plug of the battery pack.

2. The battery pack leakage inspection system of claim 1,
wherein the first mask comprises a first module and a second module, each of which is provided with a first masking jig connected to the coolant channel nipple, and
wherein the first module and the second module respectively comprise multi-axis servo actuators configured to be driven individually to adjust a distance and an angle based on a position of the coolant channel nipple.

3. The battery pack leakage inspection system of claim 2, wherein each of the first module and the second module comprises:
a first base plate connected to a support plate and configured to move up and down along a Z-axis;
a first operation plate connected to the first base plate and configured to move forward and backward along a Y-axis;
a second operation plate connected to the first operation plate and configured to move forward and backward along an X-axis; and
a jig plate connected to the second operation plate and configured to be rotatable around the Z-axis, the jig plate mounted with the first masking jig.

4. The battery pack leakage inspection system of claim 3, further comprising:
a unit plate connected to the base frame and configured to move forward and backward along the Y-axis, to which the support plate is secured,
wherein the first module and the second module are supported on the unit plate and configured to move as a single body.

5. The battery pack leakage inspection system of claim 1,
wherein the second mask comprises a rotation module including a second masking jig connected to the pressure regulator of the battery pack, and a support module to which the rotation module is rotatably connected, and
wherein the rotation module comprises at least one pair of rotation modules operating individually corresponding to the position of the pressure regulator and configured to be adjusted in position and angle.

6. The battery pack leakage inspection system of claim 5,
wherein the support module comprises:
a first body secured to a first support frame and configured to move forward and backward along the X-axis on the base frame, and provided with a ring gear; and
a second body secured to a lower end of the first body and provided with a ring rail on a bottom surface thereof, and
wherein the rotation module comprises:
a prop connected to the ring rail;
a first bracket disposed on the prop;
a roller pinion rotatably connected to the first bracket and engaging with the ring gear; and
a second bracket configured to move along the prop and mounted with the second masking jig.

7. The battery pack leakage inspection system of claim 6, wherein the prop comprises a structure configured to:
extend radially from a center of the ring gear; and
rotate along the ring rail around the center of the ring gear.

8. The battery pack leakage inspection system of claim 6, wherein the second masking jig is mounted on the second bracket and configured to move up and down on the second bracket.

9. The battery pack leakage inspection system of claim 1, wherein the third mask comprises:
a second support frame configured to move forward and backward along an X-axis on the base frame;
a second base plate connected to the second support frame and configured to move up and down along a Z-axis; and
a jig frame connected to the second base plate and configured to move forward and backward along a Y-axis, the jig frame mounted with a third masking jig to be connected to the high voltage plug and the ICCU plug.

10. The battery pack leakage inspection system of claim 9, wherein the third masking jig is mounted on the jig frame and configured to move forward and backward on the jig frame.

11. A battery pack leakage inspection apparatus comprising:
a base frame comprising a support on which a battery pack is placed;
a first mask installed on the base frame and configured to mask a coolant channel nipple of the battery pack, the first mask including:
a first module comprising a first multi-axis servo actuator provided with a first masking jig connected to the coolant channel nipple; and
a second module comprising a second multi-axis servo actuator provided with the first masking jig connected to the coolant channel nipple;
a controller configured to control driving the first multi-axis servo actuator and the second multi-axis servo actuator to adjust distances and angles based on a position of the coolant channel nipple;
a second mask installed on the base frame separately from the first mask and configured to mask a pressure regulator of the battery pack; and
a third mask installed on the base frame separately from the second mask and configured to mask a high voltage plug and an integrated charging control unit (ICCU) plug of the battery pack.

12. The battery pack leakage inspection apparatus of claim 11,
wherein each of the first module and the second module comprises:
a first base plate connected to a support plate;
a first operation plate connected to the first base plate;
a second operation plate connected to the first operation plate; and
a jig plate connected to the second operation plate, the jig plate mounted with the first masking jig, and
wherein the controller is further configured to:
control movement of the first base plate to move up and down along a Z-axis;
control movement of the first operation plate to move forward and backward along a Y-axis;
control movement of the second operation plate to move forward and backward along an X-axis; and
control rotation of the jig plate around the Z-axis.

13. The battery pack leakage inspection apparatus of claim 12, further comprising:
a unit plate connected to the base frame,
wherein the controller is further configured to control movement of the unit plate to move forward and backward along the Y-axis, to which the support plate is secured,
wherein the first module and the second module are supported on the unit plate and configured to move as a single body.

14. The battery pack leakage inspection apparatus of claim 11,
wherein the second mask comprises a rotation module including a second masking jig connected to the pressure regulator of the battery pack, and a support module to which the rotation module is rotatably connected, and
wherein the rotation module comprises at least one pair of rotation modules operating individually corresponding to the position of the pressure regulator and configured to be adjusted in position and angle.

15. The battery pack leakage inspection apparatus of claim 14,
wherein the support module comprises:
a first body secured to a first support frame and provided with a ring gear; and
a second body secured to a lower end of the first body and provided with a ring rail on a bottom surface thereof,
wherein the controller is further configured to control movement of the first body to move forward and backward along the X-axis on the base frame, and
wherein the rotation module comprises:
a prop connected to the ring rail;
a first bracket disposed on the prop;
a roller pinion rotatably connected to the first bracket and configured to engage with the ring gear; and
a second bracket configured to move along the prop and mounted with the second masking jig.

16. The battery pack leakage inspection apparatus of claim 15, wherein the prop comprises a structure configured to:
extend radially from a center of the ring gear; and
rotate along the ring rail around the center of the ring gear.

17. The battery pack leakage inspection apparatus of claim 16,
wherein the second masking jig is mounted on the second bracket, and
wherein the controller is further configured to control movement of the second masking jig to move up and down on the second bracket.

18. The battery pack leakage inspection apparatus of claim 11,
wherein the third mask comprises:
a second support frame;
a second base plate connected to the second support frame;
a jig frame connected to the second base plate and mounted with a third masking jig for connection to the high voltage plug and the ICCU plug, and
wherein the controller is further configured to:
control movement of the second support frame to move forward and backward along an X-axis on the base frame;
control movement of the second plate to move up and down along a Z-axis; and
control movement of the jig frame to move forward and backward along a Y-axis.

19. The battery pack leakage inspection apparatus of claim 18,
wherein the third masking jig is mounted on the jig frame, and
wherein the controller is further configured to control movement of the third masking jig to move forward and backward on the jig frame.
